(19) United States
(12) Patent Application Publication
(10) Pub. No.: US 2003/0158935 A1
(43) Pub. Date: Aug. 21, 2003

(54) Real-time situation report system and method

(76) Inventors: Chaucer Chiu, Taipei (TW); Xu Dong Wang, Shanghai (CN)

Correspondence Address: JACOBSON HOLMAN PLLC, 400 SEVENTH STREET N.W., SUITE 600, WASHINGTON, DC, 20004, US

(21) Appl. No.: 10/075,768

(22) Filed: Feb. 15, 2002

(51) Int. Cl. G06F 15/173

(52) U.S. Cl. 709/224; 709/238

(57) ABSTRACT

A real-time situation report system and method are disclosed herein. Through a network environment, a server host on one end and a mobile electronic networking device on another end are connected. Situation messages are transmitted to users using a transfer protocol. With the operation of the system and method, users can know of what is happening from a moving or fixed terminal.

### BACKGROUND OF THE INVENTION

1. Field of Invention

The invention relates to a real-time situation report system and method and, in particular, to a system and method for electronic networking devices.

2. Related Art

Conventional situation report systems mainly send a voice message or make a call through telephones to report current abnormal situations occurred to the system. The manager then goes to the place where the situations happen to solve the problems.

However, these conventional situation report systems have some drawbacks. One of them is that the warning is usually provided to the manager, and then the manager goes to solve the problem on scene. Sometimes, only the manager can learn of the more accurate situation from his or her office and then go to solve the problem. Such a method often makes situation more complicated or even perilous because the problem cannot be solved immediately. Furthermore, even if the system provides a warning to the manager, such a signal only notifies the manager that there are problems without indicating where the problem is or what happens. Thus, the problem cannot be solved immediately either.

If the manager is not in the office but some emergent situation happens, then the conventional situation report system cannot notify the manager immediately. As described before, the manager thus usually misses the best time for solving the problems. If the problem is minor, the manager may only experience some troubles; but if the problem is serious, it may cause great loss to the company.

Therefore, it is highly desirable to provide an improved solution to the above drawback. With the user of modern electronic techniques, the user can understand the situations of the whole environment using a mobile phone or a PDA (personal digital assistant) that can link with the network. Then the user can go to solve any problem on scene as soon as possible. For more serious or dangerous problems, the user can even notify the police for further help. The invention thus allows the manager to understand all situations and to make immediate responses.

### SUMMARY OF THE INVENTION

In view of the foregoing problems, an objective of the invention is to provide a real-time situation report system and method, which link a server host on one end to a mobile electronic networking device on another end through a network and transmit situation messages to a user using a common transfer protocol.

Another objective of the invention is to provide a real-time situation report system and method, which allows to learn of what are happening from a mobile or a fixed terminal. The system includes at least a signal control module, an I/O (input/output) unit, an access database, and a central processing module. The signal control module receives abnormal signals. The I/O unit is connected with the signal control module and a mobile electronic networking device for transmitting situation messages. The access database stores a situation report program and multimedia data. The central processing module is connected withy the I/O unit and the access database for transmitting and receiving data, messages and commands to and from the I/O unit and the access database.

### BRIEF DESCRIPTION OF THE DRAWINGS

The invention will become more fully understood from the detailed description given hereinbelow illustration only, and thus are not limitative of the present invention, and wherein:

FIG. 1 is a schematic view showing the relation between the disclosed real-time situation report system and a mobile electronic networking device;

FIG. 2 is a schematic view showing the relation among the disclosed signal control module and sensors; and

FIG. 3 shows the operation procedure of the real-time situation report method.

### DETAILED DESCRIPTION OF THE INVENTION

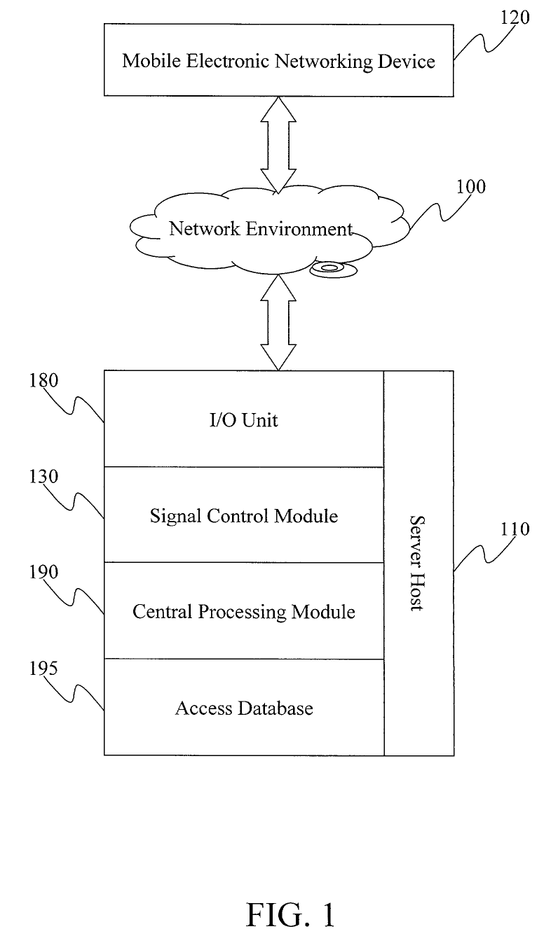

This specification discloses a real-time situation report system and method, which connects a server host on one end and a mobile electronic networking device on another end through a network to transmit situation messages to users using a common transfer protocol. Through the operation of the system and method, a user can learn of what is happening from a mobile or fixed terminal. From FIG. 1, we can understand the relation between a mobile electronic networking device 120 and a server host 110 and important components and modules inside the server host 110.

First, the mobile electronic networking device 120 is connected to the server host 110 through a network environment 100. The server host 110 is comprised of an I/O unit 180, a signal control module 130, a central processing module 190 and an access database 195. The signal control module 130 receives abnormal signals. The I/O unit 180 is connected with the signal control module 130 and a mobile electronic networking device 120 for transmitting situation messages. The access database 195 stores a situation report program and multimedia data. The central processing module 190 is connected withy the I/O unit 180 and the access database 195 for transmitting and receiving data, messages and commands to and from the I/O unit 180 and the access database 195.

The mobile electronic networking device 120 can be selected from the group consisting of a mobile phone, a PDA (personal digital assistant), and a notebook computer.

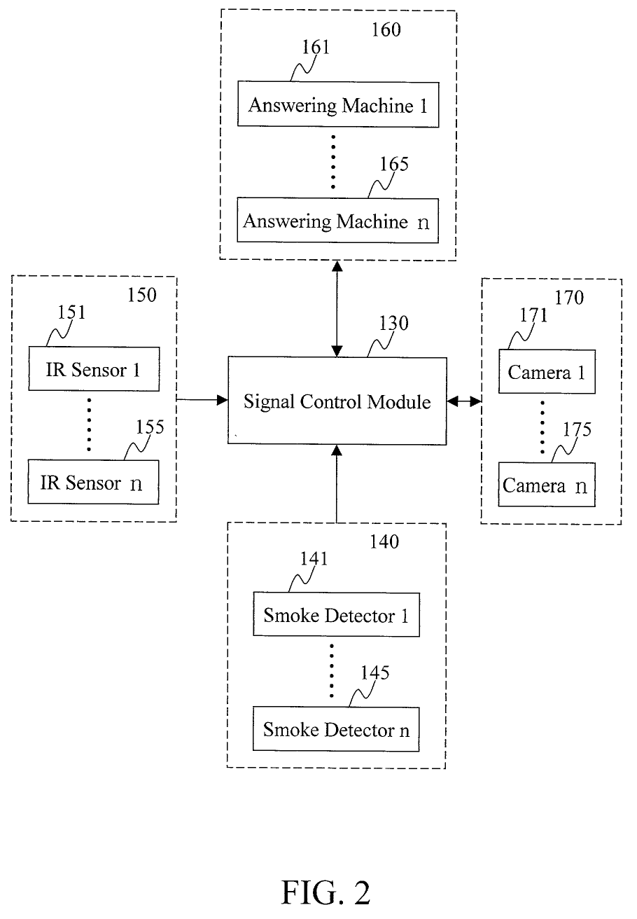

As shown in FIG. 2, abnormal signals come from sensors. The signal control module 130 can connect to a smoke detector group 140 (smoke detector 1 141, . . . , smoke detector n 145), an IR (infrared) sensor group (IR sensor 1 151, . . . , IR sensor n 155), an answering machine group 160 (answering machine 1 161, . . . , answering machine n 165), and a camera group 170 (camera 1 171, . . . , camera n 175).

In the following texts, we will explain the whole system with simultaneous reference to FIGS. 1 and 2. Suppose the smoke detector 1 141 detects excess smoke at its location, an abnormal signal is immediately transmitted to the signal control module 130. After receiving the signal, the signal control module 130 first starts nearby cameras and then sends an abnormal signal and the information on the smoke detector 1 141 to the server host 110. After receiving the abnormal signal and the information on the smoke detector 1 141, the central processing module 190 in the server host 110 first retrieves the physical position data of all the smoke detectors in the smoke detector group 140 from the access database 195. After comparison and organization, a situation message is generated and transmitted to the I/O unit 180.

Afterwards, the I/O unit 180 transmits the situation message to the mobile electronic networking device 120 through the network 100 using a common transfer protocol. The mobile electronic networking device displays the situation message to the user. The transfer protocol is selected from the group consisting of HTTP (hypertext transfer protocol), FTP (file transfer protocol), WAP (wireless application protocol), GPRS (general packet radio service, GSM (global system for mobile), W-CDMA (wideband code division multiple access), IR wireless transfer protocol, Bluetooth, IEEE802.11a Standards, IEEE802.11b Standards, wireless LAN (local area network). What the user receives the situation message, he or she can clearly understand when, where, and what is happening.

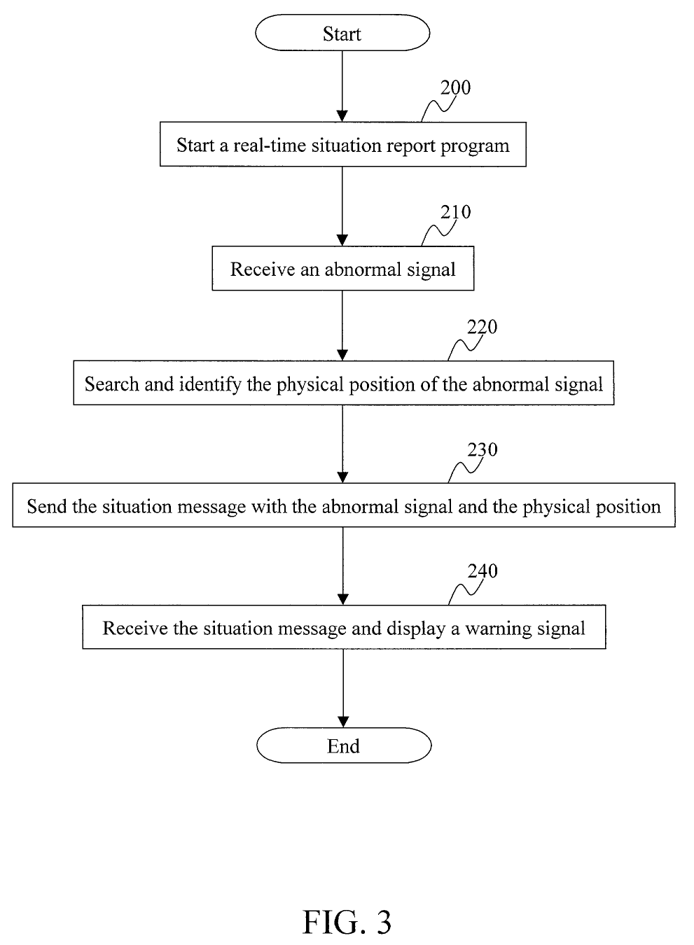

With reference to FIG. 3, after the user starts the real-time situation report program of the system (step 200), the user can communicate with the server host 110 from any electronic networking device 120 that can connect to the network. Suppose the user is using a PDA as the electronic networking device 120 and starts the real-time situation report program of the system. When the signal control module 130 receives an abnormal signal sent out from some sensor, the signal control module 130 immediately transmits the abnormal signal to the server host 110 of the system. The I/O unit 180 of the server host 110 receives an abnormal signal (step 210). The system starts to search and identify the physical position of the abnormal signal (step 220). After making sure of the physical position and organizing the data, the I/O unit 180 of the system sends out the situation message of the abnormal signal and the physical position to the PDA (step 230). The situation message and a warning signal are displayed on the PDA (step 240). After reading the situation message from the server host, the user can make instantaneous responses to the actual situation.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A real-time situation report system for linking a server host and a mobile electronic networking device through a network environment to transmit a situation message to a user using a common transfer protocol, which server host comprising:
a signal control module receiving an abnormal signal;
an I/O (input/output) unit connecting with the signal control module and the mobile electronic networking device for transmitting the situation message;
an access database storing a situation report program and multimedia data; and
a central processing module connecting with the I/O unit and the access database for transmitting and receiving data, messages and commands to and from the I/O unit and the access database.

2. The system of claim 1, wherein the mobile electronic networking device is selected from the group consisting of a mobile phone, a PDA (personal digital assistant), and a notebook computer.

3. The system of claim 1, wherein the transfer protocol is selected from the group consisting of HTTP (hypertext transfer protocol), FTP (file transfer protocol), WAP (wireless application protocol), GPRS (general packet radio service, GSM (global system for mobile), W-CDMA (wideband code division multiple access), IR wireless transfer protocol, Bluetooth, IEEE802.11a Standards, IEEE802.11b Standards, wireless LAN (local area network).

4. The system of claim 1, wherein the signal control module is further coupled to at least one sensor.

5. The system of claim 4, wherein the sensor is selected from the group consisting of a camera, an answering machine, a smoke detector, and an IR sensor.

6. The system of claim 1, wherein the situation message comprises the abnormal signal and a physical position.

7. The system of claim 6, wherein the physical position refers to the location of the sensor.

8. The system of claim 1, wherein the abnormal signal refers to a message generated by a sensor when it senses an abnormal situation.

9. The system of claim 1, wherein the multimedia data refer to contents generated through combinations of texts, voices, pictures, and videos sensible by human beings in a digital form.

10. A real-time situation report method for linking a server host and a mobile electronic networking device through a network environment to transmit a situation message to a user using a common transfer protocol, comprising the steps of:
starting a situation report program;
receiving an abnormal signal;
searching and identifying a physical position corresponding to the abnormal signal;
sending a situation message with the abnormal signal and the physical position; and
receiving the situation message and displaying a warning signal through the mobile electronic networking device.

11. The method of claim 10, wherein the mobile electronic networking device is selected from the group consisting of a mobile phone, a PDA (personal digital assistant), and a notebook computer.

12. The method of claim 10, wherein the transfer protocol is selected from the group consisting of HTTP (hypertext transfer protocol), FTP (file transfer protocol), WAP (wireless application protocol), GPRS (general packet radio service, GSM (global system for mobile), W-CDMA (wideband code division multiple access), IR wireless transfer protocol, Bluetooth, IEEE802.11a Standards, IEEE802.11b Standards, wireless LAN (local area network).

13. The method of claim 10, wherein the abnormal signal refers to a message generated by a sensor when it senses an abnormal situation.

14. The method of claim 10, wherein the physical position refers to the location of the sensor.

15. The method of claim 10, wherein the warning signal is selected from the group consisting of combinations of texts, voices and pictures.
